(19) United States
(12) Patent Application Publication
(10) Pub. No.: US 2003/0006830 A1
(43) Pub. Date: Jan. 9, 2003

(54) MOSFET resistant control circuit and time constant control circuit used therewith

(75) Inventor: Shuhei Kawauchi, Sapporo-shi (JP)

Correspondence Address: SUGHRUE MION, PLLC, 2100 PENNSYLVANIA AVENUE, N.W., WASHINGTON, DC, 20037, US

(73) Assignee: A&CMOS COMMUNICATION DEVICE INC.

(21) Appl. No.: 10/190,506

(22) Filed: Jul. 9, 2002

(30) Foreign Application Priority Data
Jul. 9, 2001 (JP) 2001-208208

(51) Int. Cl. G05F 1/10

(52) U.S. Cl. 327/538

(57) ABSTRACT

In a resistance control circuit, each source electrode of the first and second MOSFETs is connected to VDD, respectively, the first current source is connected to a point between a drain electrode of the first MOSFET and the ground, a non-reverse input terminal of an operation amplifier is connected to a drain electrode of the first MOSFET, and an output terminal of the operation amplifier is connected to the first and second MOSFETs. A voltage applying device applies a predetermined voltage to the reverse input terminal of the operation amplifier so that the MOSFETs is operated in MOS Ohmit region.

### BACKGROUND OF THE INVENTION

1. Field of the Invention

The present invention relates to a MOSFET (MOS type Field-Effecf-Transitor) resistance control circuit and a time constant control circuit used with the MOSFET resistant control circuit.

2. Discussion of the Related Art

For example, FIG. 9 shows a control circuit for controlling a resistant value at a path between a gate electrode and a source electrode of a MOSFET, wherein a battery source 52 is connected at the path between the gate electrode and the source electrode of the MOSFET 51. Thereby, the resistant value at the path between the gate electrode and the source electrode can be controlled by the gate voltage. In FIG. 9, the MOSFET 51 is an n-channel type MOSFET.

However, in the structure as shown in FIG. 9, wherein the gate voltage is controlled by connecting the battery source 52 at the path between the gate electrode and the source electrode of the MOSFET 51. On the other hand, a resistant value at the pate between a drain electrode and the source electrode is baneful influenced by unevenness and temperature characteristic of the respective MOSFET.

In the case that such a structure is utilized as a time constant circuit wherein a condenser is connected to the drain electrode or the source electrode of the MOSFET 51, it is difficult to obtain a predetermined time constant stably. If such a time constant circuit is employed to an oscillation circuit, it would be difficult to obtain the predetermined oscillation frequency stably.

Upon reviewing the above drawbacks, the first purpose of the present invention is to provide a MOSFET resistance control circuit for controlling a resistant value of the MOSFET regardless unevenness and temperature characteristic of the respective MOSFET.

The second purpose of the present invention is to provide a time constant control circuit for providing a preferable time constant.

### OBJECT AND SUMMARY OF THE INVENTION

It is therefore an object of the present invention to provide a MOSFET resistance control circuit comprising an electric current mirror circuit including first and second MOSFETs of which gate electrodes are commonly connected, a first current source, an operational amplifier and voltage applying means, wherein the MOSFET resistance control circuit is characterized in that each source electrode of the first and second MOSFETs is connected to a first battery terminal, the first current source is connected to a point between a drain electrode of the first MOSFET and a second battery terminal, an output terminal of the operation amplifier is connected to each gate electrode of the first and second MOSFETs, a resistant value between the source electrode and a drain electrode of the second MOSFET is controlled in accordance with the current value of the first current source by applying a predetermined voltage at a reverse input terminal of the operation amplifier by the voltage applying means so as to operate the first and second MOSFET in a MOS Ohmit region.

In accordance with the first resistance control circuit according to the present invention as described above, the gate voltage of the first MOSFET is controlled by the operation so as to be equal to the drain voltage applied by the voltage applying means. That is, a portion between the source electrode and the drain electrode of the first MOSFET is controlled to a resistant value determined by the applied voltage value and the current value of the first current source. While a current value of the first current source is varied, a resistance between the source electrode and the drain electrode of the first MOSFET is varied. In the second MOSFET, the gate voltage is maintained at the same electric potential of the gate voltage of the first MOSFET. The second MOSFET forms an electric current mirror circuit together with the first MOSFET. Therefore, while the current value of the first current source is varied, the electric current flown into the second MOSFET is also varied. Thus, a resistant value between the source electrode and the drain electrode is varied. Accordingly, the resistant value between the source electrode and the drain electrode in the second MOSFET can be controlled regardless unevenness and temperature characteristic of the respective MOSFET, if the current value of the first current source is controlled. If the temperature characteristic of the voltage applied by the voltage applying means and the temperature characteristic of the current of the first current source are the same, influence caused thereby can be cancelled.

The second resistance control circuit according to the present invention is characterized in that voltage applying means comprises a resistance and a second current source connected in series at a path between the first battery terminal and the second battery terminal and the reverse input terminal of the operation amplifier is connected to a connecting point between the resistance and the second current source in the first resistance control circuit.

In accordance with the second resistance control circuit according to the present invention, the voltage applying means including the resistance and the second current source applies voltage to the reverse input terminal of the operation amplifier so as to operate the first and second MOSFET in the MOS Ohmit region. Under the structure, the resistant value can be controlled in accordance with a ratio of a current value of the second current source with respect to the current value of the first current source regardless unevenness and temperature characteristic of the respective second MOSFET. If the temperature characteristic of the current of the first current source and the temperature characteristic of the current of the second current source, its influence can be cancelled each other.

The third resistance control circuit according to the present invention is characterized in that voltage applying means is a battery source connected to a point between the first battery terminal and the reverse input terminal of the operation amplifier in the first MOSFET resistance control circuit,

In accordance with the third resistance control circuit according to the present invention, voltage applying means with a battery source applies voltage to the reverse input terminal of the operation amplifier so as to operate the first and second MOSFET in the MOS Ohmit region so that the resistance can be controlled in accordance with the voltage value of the battery source and the current value of the first current source. If the temperature characteristic of the voltage of the battery source and the temperature characteristic of the current of the first current source are the same, its influence can be cancelled each other.

An object of the present invention is to provide a time constant control circuit comprising one of the MOSFET resistance control circuits according to the present invention as described above and a condenser connected to the drain electrode of the second MOSFET of the resistance control circuit, the time constant control circuit is characterized in that a resistance value at a point between the source electrode and the drain electrode of the second MOSFET is controlled by the resistance control circuit so as to control a time constant of a time constant circuit including a path between the source electrode and the drain electrode of the second MOSFET and the condenser.

In accordance with the time constant control circuit according to the present invention, the resistant value of the second MOSFET can be controlled regardless the unevenness and its temperature characteristic. By setting the outer temperature characteristic preferably, its baneful influence can be avoided so that a preferable time constant can be stably obtained by the resistant value of the second MOSFET and the condenser.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a MOSFET resistance control circuit of the first embodiment of according to the present invention;

FIG. 2 shows a MOSFET resistance control circuit of the second embodiment of according to the present invention;

FIG. 3 shows a MOSFET resistance control circuit of the third embodiment according to the present invention;

FIG. 4 shows a MOSFET resistance control circuit of the fourth embodiment according to the present invention;

FIG. 5 is a time constant control circuit of one embodiment according to the present invention;

FIG. 6 is a time constant control circuit of the first modified embodiment according to the present invention;

FIG. 7 is a time constant control circuit of the second modified embodiment according to the present invention;

FIG. 8 is a time constant circuit of the third modified embodiment according to the present invention; and

FIG. 9 is a conventional MOSFET resistance control circuit.

### DETAILED DESCRIPTION OF THE INVENTION

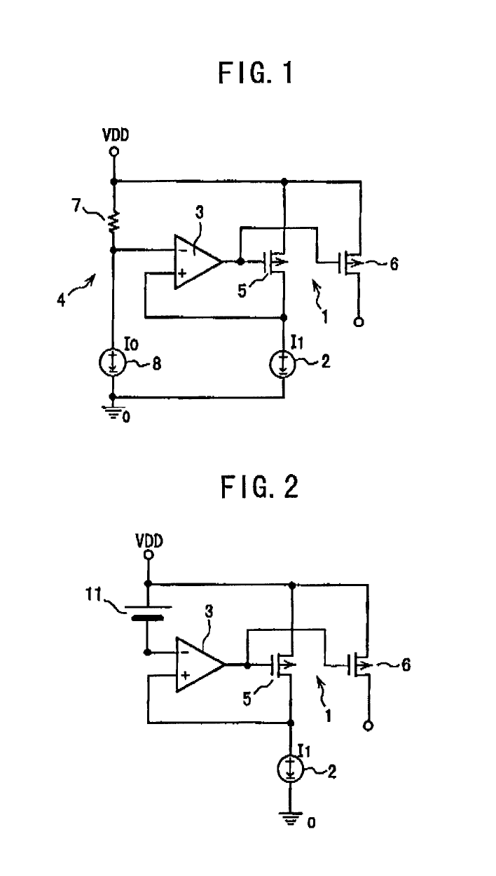

FIG. 1 shows a MOSFET resistant control circuit of the first embodiment according to the present invention. The resistance control circuit comprises an electric current mirror circuit 1, a first current source 2, an operation amplifier 3 and voltage applying means 4.

The electric current mirror circuit 1 includes a p-channel type first MOSFET 5 and a p-channel type second MOSFET 6, wherein a gate electrode is commonly connected to the both MOSFETs and each source electrode is connected to a VDD (a first battery terminal), a drain electrode of the first MOSFET 5 is connected to the ground (a second battery terminal) through the first current source 2 and also connected to a non-reverse input terminal of the operation amplifier 3 so as to connect an output terminal of the operation amplifier 3 to the gate electrode commonly connected.

The voltage applying means 4 includes a resistance 7 and a second current source 8 that are connected between the VDD and the ground. A connecting point between the resistance 7 and the second current source 8 is connected to a reverse input terminal of the operation amplifier 3. Thereby, the first and second MOSFETs 5 and 6 are operated in a MOS Ohmit region, for example, a predetermined gate voltage of 0.1.˜0.2V is applied.

Under the above structure, the gate electrodes of the first and second MOSFETs 5 and 6 are controlled by the operation amplifier 3 so as to adjust the drain voltage as the applied voltage determined by the resistance 7 and the second current source 8. That is, a path between the source electrode and the drain electrode of the first MOSFET 5 is controlled to be a resistant value determined by the applied voltage and a current amount of the first electric current source 2 so that the first MOSFET 5 can be operated in the MOS Ohmit region. Accordingly, the following equation is obtained;

R7×I0=R5×I1 (1),

wherein a resistant value of the resistance 7 is R7, a current amount of the second current source 8 is I0, a resistant value of the path between the source electrode and the drain electrode of the first MOSFET 5 is R5 and a current value of the first current source 2 is I1.

Therein, the first and second MOSFETs 5 and 6 form the electric current mirror circuit 1 For example, the resistant value (R6) of the path between a source electrode and a drain electrode of the second MOSFET 6 is adjusted to be equal to the resistant value R5 of the first MOSFET 5, that is, transistor sizes of the MOSFETS 5 and 6 are adjusted to be that the electric current ratio is 1:1. Thus, the following equation can be obtained;

R6=R7×I0÷I1 (2).

In accordance with the equation (2), the resistant value RE of the second MOSFET 6 is in proportion to the ratio of I0 with respect to I1. If the value I0 is constant, the value R6 can be controlled by controlling the value I1. A gate voltage of the second MOSFET 6 is controlled so as to be the resistant value RE constant, that is, the baneful influence caused by the temperature can be canceled by the operation amplifier so that the resistant value R6 can be controlled regardless any baneful influence of unevenness and temperature characteristic of the second MOSFET 6.

In the case that the temperature characteristics of I0 and I1 are the same, the temperature characteristics thereof can be canceled each other so that the resistant value R6 can be prevent from being influenced by the temperature characteristics of the current amounts I0 and I1.

FIG. 2 shows a MOSFET resistant control circuit of the second embodiment according to the present invention. In the second embodiment, the components and the structure are same to those of the first embodiment except a battery source 11 connected at a point between the VDD and a reverse input terminal of the operation amplifier 3 actuated as voltage applying means 4 so as to operate the first and second MOSFETs 5 and 6 in the MOS Ohmit region by the battery source 11 through the operational amplifier 3. Therefore, in the second embodiment, the same numeral is applied to the same component corresponding to the component of the first embodiment. Thus, the explanation thereof is omitted.

Under the structure, in the case of a voltage value of the battery source 11 is V11,

R6=V11/I1 (3).

If the voltage value V11 is constant, the resistant value R6 can be controlled by controlling the current amount I1 regardless any baneful influence caused by unevenness and temperature characteristic of the respective second MOSFET 6.

If the temperature characteristics of the voltage value V11 an the current amount I1 are the same, the resistant value R6 is not influenced by the temperature characteristics of V11 and I1, since the both temperature characteristics are cancelled each other.

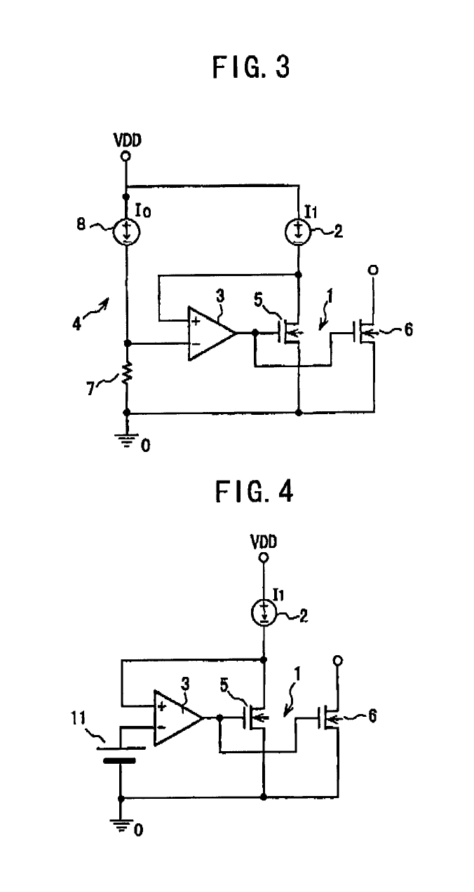

FIG. 3 shows a MOSFET resistant control circuit of the third embodiment according to the present invention. In the third embodiment, the first and second MOSFETs 5, 6 are n-channel type.

In the third embodiment, a VDD is the second battery terminal and the ground is the first battery terminal. A drain electrode of the first MOSFET 5 is connected to the VDD through the first current source 2 and also connected to a non-reverse input terminal of an operational amplifier 3. Further, a source electrode of the first MOSFET 5 is connected to the ground together with a source electrode of the second MOSFET 6 and a gate electrode of the first MOSFET 5 is connected to an output terminal of the operation amplifier 3 together with a gate electrode of the second MOSFET 6.

One of the terminals of the second current source 8 is connected to the VDD and the other terminal is connected to the ground through a resistance 7 and also connected to a reverse input terminal of the operation amplifier 3 so that a predetermined voltage is applied to each gate electrode so as to operate the MOSFETs 5 and 6 in the MOS Ohmit region.

In accordance with the third embodiment, as similar as the first embodiment, if the current value I0 of the second current source is constant, the current value I1 of the first current source 2 is controlled so that the resistant value RG of the second MOSFET 6 can be controlled regardless the baneful influence caused by unevenness and temperature characteristic of the respective second MOSFET. In the case that the temperature characteristics of the current amounts I0 and I1 are the same, the both temperature characteristics are cancelled each other so that the resistant value R6 is not influenced by the temperature characteristics of the current amounts I0 and I1.

FIG. 4 shows a MOSFET resistant control circuit of the fourth embodiment according to the present invention. The fourth embodiment has the same components and a structure of the second embodiment except the n-channel type first and second MOSFETs 5 and 6.

In the fourth embodiment, as similar as the third embodiment, a VDD is the second battery terminal, the ground is the first battery terminal and a drain electrode of the first MOSFET 5 is connected to the VDD through the first current source 2 and also connected to a non-reverse input terminal of the operation amplifier 3. A source electrode of the first MOSFET 5 is connected to the ground together with a source electrode of the second MOSFET 6 and a gate electrode of the MOSFET 6 is connected to an output terminal of the operational amplifier 3 together with the gate electrode of the second MOSFET 6.

A battery source 11 is connected to a point between the reverse input terminal of the operation amplifier 3 and the ground so that the first and second MOSFETs 5 and 6 are operated in the MOS Ohmit region by the battery source 11 through the operation amplifier 3.

In accordance with the fourth embodiment, as similar as the second embodiment, if the voltage value V11 of the battery source 11 is constant, the resistant value R6 of the second MOSFET 6 can be controlled by controlling the current amount IS of a first current source 2 regardless baneful influence caused by unevenness and temperature characteristic of the second MOSFET 6. In the case that the temperature characteristics of the voltage value V11 and the current amount I1 are equal, the both temperature characteristics are cancelled each other so that the resistant value R6 is not influenced by the temperature characteristics of the voltage value V11 and the current amount I1.

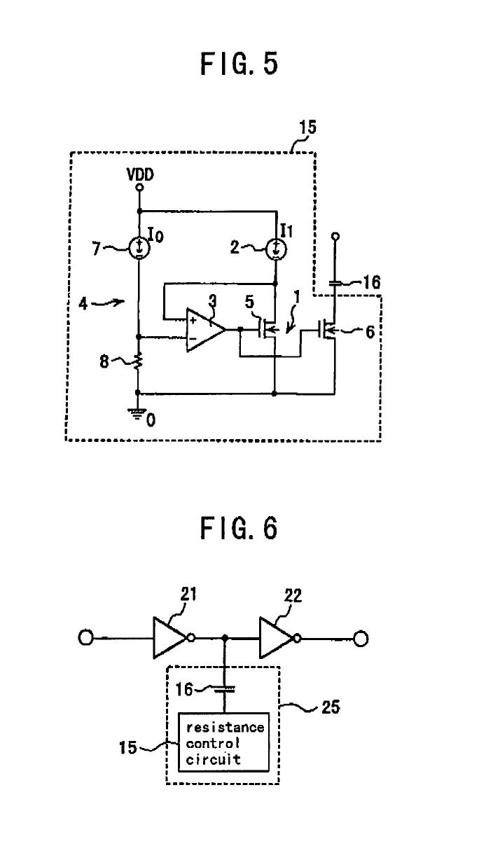

FIG. 5 shows a time constant control circuit of one embodiment according to the present invention, wherein a condenser 16 is connected to a drain electrode of a second MOSFET 6 of a resistance control circuit 15 of the MOSFET as described above. In FIG. 5, the resistance control circuit 15 is a structure as shown in FIG. 3.

In the time constant control circuit, a resistant value R6 of a second MOSFET 6 employed in the time constant circuit with the condenser 16 can be controlled regardless the influence caused by unevenness and temperature characteristic of the respective second MOSFET 6. If a temperature characteristic of the current value I0 of the second current source 3 and a temperature characteristic of a current amount I1 of the first current source 2 are adjusted to be equal, the both temperature characteristics are cancelled each other so that the resistant value R6 is not influenced by outer temperature characteristics of the current amounts I0 and I1. The time constant circuit can control a predetermined time constant stably by controlling the resistant value R6.

Although the structure of the resistance control circuit as shown in FIG. 3 is employed as the resistance control circuit 15 in FIG. 5, the other resistance control circuits as shown in FIGS. 1, 2 and 4 may he employed to a time constant control circuit.

FIG. 6 is another time constant control circuit of the first modified embodiment according to the present invention. In the embodiment, a plurality of inverters are connected in series. A time constant control circuit 25 including a resistant control circuit 15 and a condenser 16 as described above is connected to a point between two inverters 21 and 22 in a delay time control circuit so that a delay time can be varied by controlling a time constant of the time constant control circuit 25.

In the case that the time constant control circuit 25 according to the present invention is applied to a delay time control circuit, the time constant can be stably controlled in the time constant control circuit 25. Therefore, a preferable delay time can be stably obtained.

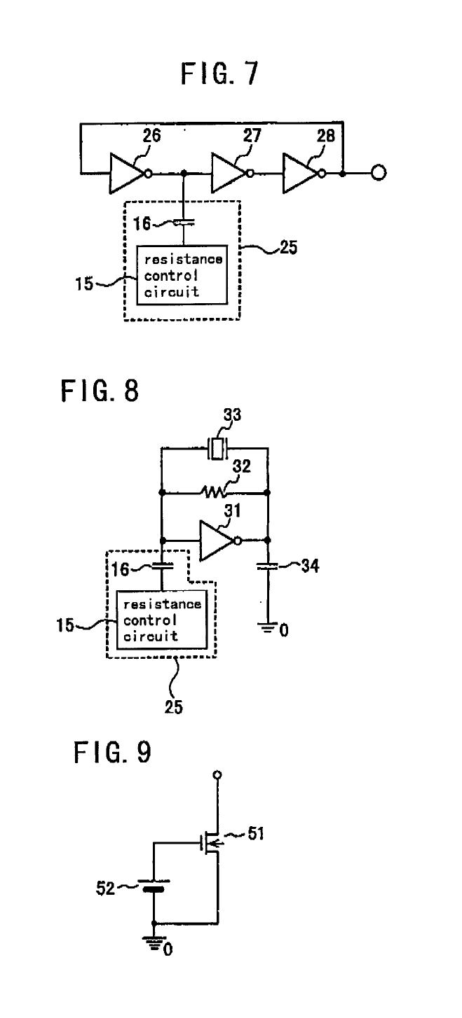

FIG. 7 shows a time constant control circuit of the second modified embodiment according to the present invention. In the second modified embodiment, odd number inverters, for example, three inverters 26, 27 and 28 are connected in a ring shape, wherein a time constant control circuit 25 including a resistance control circuit 15 according to the present invention and the condenser 16 is connected to a point between the inverter 26 and the inverter 27 so as to control a time constant of the time constant control circuit 25 so that oscillation frequency of a ring oscillator can be varied.

As described above, if the time constant control circuit 25 according to the present invention is applied to a ring oscillator, the time constant can be controlled stably in the time constant control circuit 25 so that a preferable oscillation frequency can be obtained.

FIG. 8 shows a time constant control circuit of the third modified embodiment according to the present invention. In the third modified embodiment, a crystal oscillation circuit comprises an inverter 31, a resistance 32 and a crystal oscillator 33 are connected in parallel, wherein the time constant control circuit 25 including a resistant control circuit 15 and the condenser 16 as described above is connected to an input side of the inverter 31 and a condenser 34 is connected to an output side of the inverter 31. Under the condition, a time constant of the time constant control circuit 25 is controlled so that the oscillation frequency can be varied.

As described above, in the case that the time constant control circuit 25 according to the present invention is applied to an oscillation circuit, the time constant can be controlled stably in the time constant control circuit 25 so that a preferable oscillation frequency can be stably obtained.

Although the time constant control circuit 25 is connected to the input side of the inverter in FIG. 8, the time constant control circuit 25 may be connected to an output side instead of the input side or the both input and output sides.

The present invention is not limited to the structures as described above. These structures can be modified within an essence of the present invention. For example, in the embodiments as described above, an electric current ratio of the first MOSFET 5 with respect to the second MOSFET 6 may be 1:1 in an electric mirror circuit 1. However, such a ratio can be optionally changed by adjusting the size of these transistors. Thereby, the resistant value R6 can be weighted. The resistance control circuit of the MOSFET according to the present invention can be applied to a variable resistance in addition to a time constant control circuit. Likewise, the time constant control circuit can be applied to a ceramic oscillation circuit and the other various circuit using a time constant circuit in addition to the delay time control circuit, the ring oscillator and the crystal oscillator circuit as described above.

As described above, in accordance with the MOSFET resistance control circuit according to the present invention, each source electrode of the first and second MOSFETs in an electric current mirror circuit is connected to a first current terminal, respectively. The first current source is connected to a point between a drain electrode of the first MOSFET and the second current source. A drain electrode of the second MOSFET is connected to a non-reverse input terminal of an operation amplifier. An output terminal of the operation amplifier is connected to the both gate electrodes of the first and second MOSFETs and a preferable voltage is applied to a reverse input terminal of the operation amplifier by voltage applying means so as to operate the first and second MOSFETs in the MOS Ohmit region. Therefore, a resistant value of the second MOSFET can be controlled to a preferable value regardless baneful influence caused by unevenness and temperature characteristic of the second MOSFET.

In accordance with a time constant control circuit according to the present invention, a condenser is connected to a drain electrode of the second MOSFET in the resistance control circuit described above, a preferable time constant can be obtained stably.

Other structures and functions that may be disclosed in Japanese Patent Application 2001-208208, filed on Jul. 9, 2001 are hereby incorporated by reference into this application.

The invention being thus described, it will be obvious that the same may be varied in many ways. Such variations are not to be regarded as a departure from the sprit and scope of the invention, and all such modification as would be obvious to one skilled in the art are intended to be included within the scope of the following claims.

What is claimed is:

1. MOSFET resistance control circuit comprising an electric current mirror circuit including first and second MOSFETs of which gate electrodes are commonly connected, a first current source, an operational amplifier and voltage applying means, said MOSFET resistance control circuit is characterized in that each source electrode of said first and second MOSFETs is connected to a first battery terminal, said first current source is connected to a point between a drain electrode of said first MOSFET and a second battery terminal, an output terminal of said operation amplifier is connected to each gate electrode of said first and second MOSFETs, a resistant value between said source electrode and a drain electrode of said second MOSFET is controlled in accordance with said current value of said first current source by applying a predetermined voltage at a reverse input terminal of said operation amplifier by said voltage applying means so as to operate said first and second MOSFET in a MOS Ohmit region.

2. The MOSFET resistance control circuit as claimed in claim 1 characterized in that said voltage applying means comprises a resistance and a second current source connected in series inserted into a path between said first battery terminal and said second battery terminal and said reverse input terminal of said pg,23 operation amplifier is connected to a connecting point between said resistance and said second current source.

3. The MOSFET resistance control circuit as claimed in claim 1 characterized in that said voltage applying means is a battery source connected to a point between said first battery terminal and said reverse input terminal of said operation amplifier.

4. Time constant control circuit comprising said MOSFET resistance control circuit as claimed in one of claims 1 through 3 and a condenser connected to said drain electrode of said second MOSFET of said resistance control circuit, said time constant control circuit characterized in that a resistance value at a point between said source electrode and said drain electrode of said second MOSFET is controlled by said resistance control circuit so as to control a time constant of a time constant circuit including a path between said source electrode and said drain electrode of said second MOSFET and said condenser.
